(19) United States
(12) Patent Application Publication
(10) Pub. No.: US 2018/0310492 A1
(43) Pub. Date: Nov. 1, 2018

(54) Y-SHAPED STAKE FOR FRUIT CULTIVATION

(71) Applicant: Bacchus GmbH, Oelsnitz/Vogtl (DE)

(72) Inventor: Wolfgang MEISER, Saarbruecken (DE)

(73) Assignee: Bacchus GmbH, Oelsnitz/Vogtl (DE)

(21) Appl. No.: 15/773,689

(22) PCT Filed: Sep. 20, 2016
(86) PCT No.: PCT/DE2016/100439

§ 371 Date: May 4, 2018

(51) Int. Cl. A01G 17/06; A01G 9/12; F16B 7/22

(52) U.S. Cl. CPC A01G 17/06; F16B 7/22; A01G 9/126; A01G 9/122

(57) ABSTRACT

The invention relates to a y-shaped stake for fruit-growing, in particular for the growing of table grapes.

The object of the invention consists in creating an improved Y-shaped stake for fruit-growing, which is easily transportable and quick to assemble.

This object is solved in the scope of the invention, in that an elongated base body and two side arms are provided, wherein the base body comprises openings for the insertion of at least one side arm each, wherein the inserted side arms are angled towards the upper end of the base body, wherein, between the openings and the upper end of the base body, a substantially horizontal through-opening is provided, through which a securing rod can be pushed through, wherein the securing rod, via at least one locking means, is horizontally securable against a displacement in the through-hole, and which connects the securing rod releasably connectable with the at least one side arm.

The invention relates to a Y-shaped stake for the growing of fruit, in particular for the growing of table grapes.

From the EP 2 540 154 B1, a stake for the holding of wires, in viticulture and fruit-growing, is known, which comprises a base body with a first and second limb made of sheet metal, on which a transverse beam running at right angles to the longitudinal axis is arranged with a plurality of hooks for holding the wires, wherein the transverse beam can be inserted into an opening of the base body, and can be form-fittingly locked therein by means of a quick-action closure.

From the CN 202697405, a Y-shaped support for viticulture is known. It includes a vertical area, and a V-shaped area adjoining thereto, and protects the vines better against bad weather and offers them more space.

The U.S. Pat. No. 5,557,883 A describes a support for raisins dried on the vineyard stake with a bifurcation of the supporting arm.

The object of the invention consists in creating an improved Y-shaped stake for fruit-growing, which is easily transportable and quick to assemble.

This object is solved, in the scope of the invention, in that an elongated base body and two side arms are provided, wherein the base body comprises openings for the insertion of at least one side arm each, wherein the inserted side arms are angled towards the upper end of the base body, wherein, between the openings and the upper end of the base body, a substantially horizontal through-opening is provided, through which a securing rod can be pushed through, wherein the securing rod, via at least one locking means, is horizontally securable against a displacement in the through-hole, and the securing rod is releasably connectable with the at least one side arm.

In each of the openings of the base body, one side arm respectively can be inserted, wherewith a Y-shaped stake is formed out of the base body and the two side arms angled obliquely upward.

The side arms are secured in that a securing rod is pushed through the through-opening, and this securing rod is fixed in the through-opening, and subsequently, the end regions of the securing rod are respectively connected with one of the side arms. It is also possible to provide only one side arm, wherein this side arm is secured with a shorter securing rod then, which only extends from the through-opening to the side arm.

It is provided that the securing rod comprises a plurality of hooks and/or eyelets for holding the wires.

Likewise, it is provided for that the base body comprises a plurality of hooks and/or eyelets for holding the wires.

The securing rod can comprise an I-, L-, U- or Y-shaped cross-section (profile).

The base body can comprise an L-, U- or V-shaped cross-section (profile).

An advantageous configuration of the invention consists in that the locking means comprise an inherently rigid stopper butting against the base body in the locking position and provided for on the securing rod, as well as a spring-elastic sheet-metal tongue molded on the securing rod, which interacts, to generate a form-fitting connection, with a latching receptacle on the base body, in order to secure the securing rod in the locking position against a movement relative to the base body.

In this context, it is provided for that the securing rod consists of a sheet-metal profile, and that the spring-elastic sheet-metal tongue is formed out of the sheet-metal profile of the securing rod by punching out and deformation of a tongue-shaped section.

It is advantageous that the spring-elastic sheet-metal tongue includes a spring portion protruding out of the sheet-metal profile of the securing rod at an angle of approx. 70 to 90°, preferably at approx. 80°, and a support portion mining substantially parallel to the outer side of the securing rod, on the free end of which a support surface is formed, via which the securing rod, in the locking position, can be supported on the base body.

In a different configuration of the invention, the locking means include a bore-hole in the securing rod, as well as a bore-hole in the base body, wherein fastening means are pushable and securable through the bore-hole in the base body, and through the bore-hole in the securing rod.

As fastening means, all single or two-part fastening means are provided for, which permit the securing rod and the base body to be secured form- and force-fittingly to one another through the respective bore-holes, which are arranged in alignment with one another. For example, the fastening means can be a screw, which is secured by a nut, or a T-element with a bore-hole in the main limb, through which an eyelet or a rod can be stuck. Likewise, it is advantageous that the fastening means comprises a base body (flat head) with two arms, wherein the arms are bendable with respect to the base body (compared with cotter pins for the shipment of pre-punched air cushion mailing bags/envelopes).

Advantageously, it is furthermore provided for, that, in the area of the openings and/or the side arms, securing means for the securing of the side arms inserted into the opening are provided for.

The securing means can be formed as projections arranged on the side arms, which protrude into the corresponding openings of the base body (comparable to pegboards). The securing means can likewise be formed as projections arranged on the base body, which protrude into the corresponding openings of the side arms. For example, the projections of the side arms can be brought into the openings when the side arms are arranged substantially parallel to the base body, and can secure the side arms in their position, when these have reached their desired angle to the base body.

It is provided for in the scope of the invention that, for the detachable connection of the securing rod with the side arms, a screw connection is respectively provided for between the securing rod and one of the side arms.

It is provided for according to the invention that the inserted side arms are angled towards the upper end of the base body at an angle a of approx. 40 to 60°, preferably of approx. 50°.

In the scope of the invention, it is provided that at least one coupling means for a net support cover is arrangeable on the upper end of the base body.

An advantageous configuration of the invention provides that the base body comprises an approximately L-, U- or V-shaped profile, on which, in the area for the receiving of wire frames, outside-lying hooks are arranged, wherein the hooks, in the area of the wire frames for fruit-growing, are formed as upwardly open (to the upper end of the base body) single hooks. The hooks are formed by punching out, to form a punched hole, and deforming of tongues out of the L-, U- or V-shaped profile. It is provided for that each of the hooks comprises a flank protruding out of the limb of the L-, U- or V-profile, wherein the flank merges into a tongue extending approximately parallel to the limb, and the tongue comprises a hook member expanding towards the open end, which lies opposite a tapered section of the punched hole.

Subsequently, the invention is detailed further, but not limited thereto, by means of drawings. The figures show in:

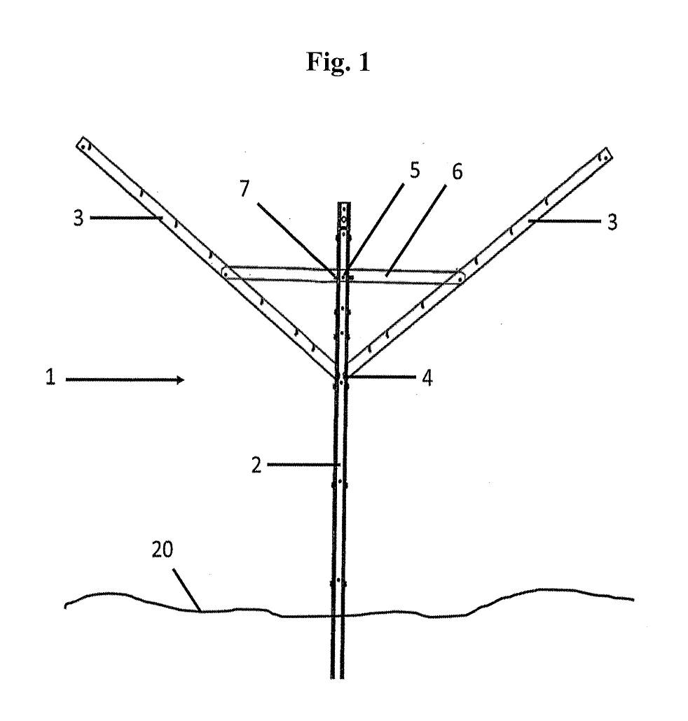

FIG. 1 a Y-shaped stake for fruit-growing in a side view,

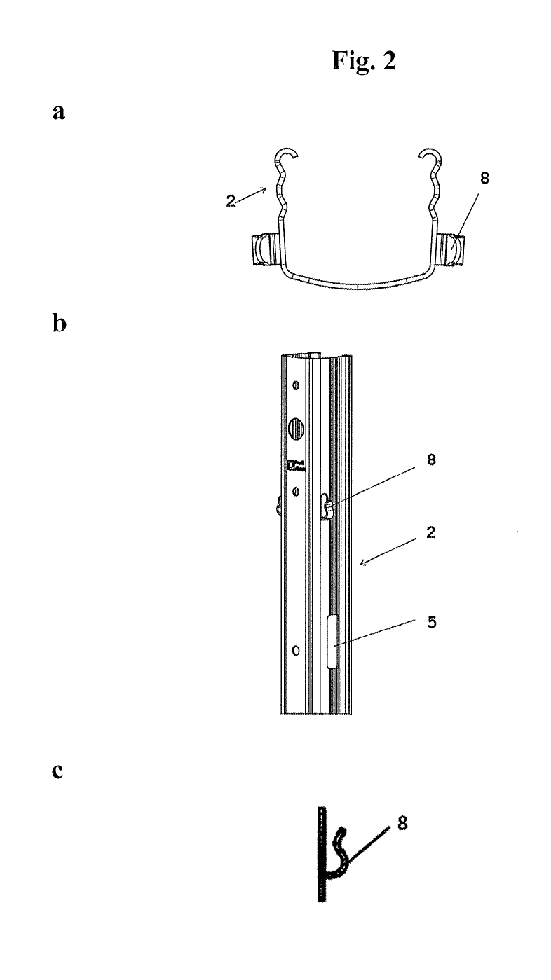

FIG. 2a a section through the base body of a Y-shaped stake for fruit-growing in plan view,

FIG. 2b a base body of a Y-shaped stake for fruit-growing, with a substantially horizontal through-opening, as well as hooks for the suspension of wire in viticulture or fruit-growing, in perspective view,

FIG. 2c hooks for suspending wires in viticulture and fruit-growing, in side-view

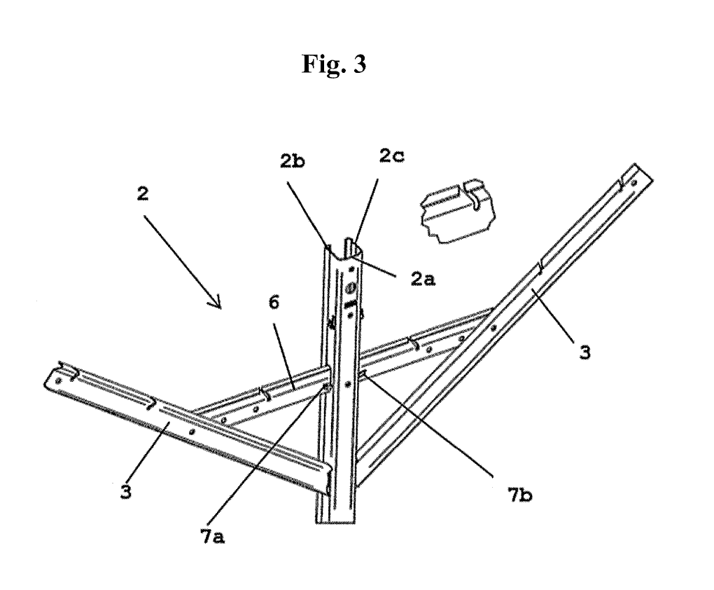

FIG. 3 a detachable connection of the securing rod with the base body, in perspective view,

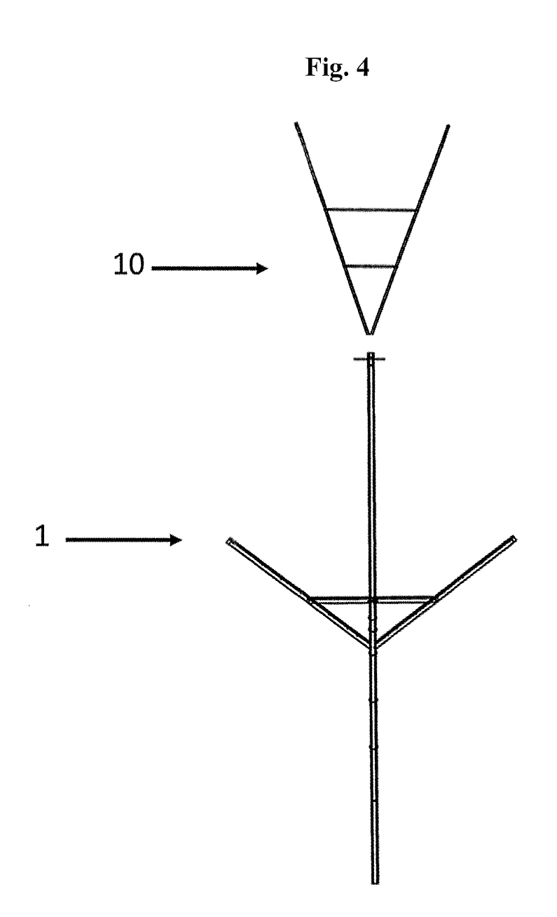

FIG. 4 a Y-shaped stake for fruit-growing in side-view, wherein the base body, via at least one coupling means, is connectable with a net support cover,

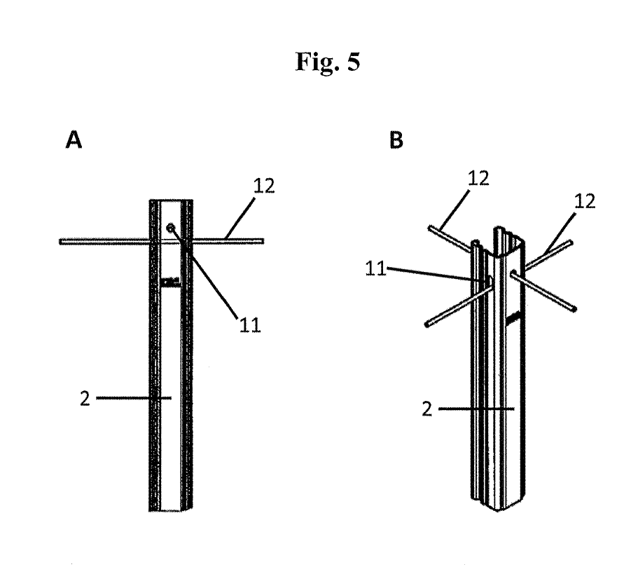

FIG. 5a Coupling means for a net support cover in side view, and

FIG. 5b Coupling means for a net support cover in perspective view.

In FIG. 1, a Y-shaped stake (1) for fruit-growing is represented in a side-view. The Y-shaped stake (1) includes a elongated base body (2) and two side arms (3). The base body (2) comprises openings (4) for the insertion of at least one side arm (3) each. The inserted side arms (3) are angled at an angle a of approx. 40 to 60°, preferably of approx. 60°, towards the upper end of the base body. Between the openings (4) and the upper end of the base body (2), at least one substantially horizontal through-opening (5) is provided, through which a securing rod (6) can be pushed through and is securable in it via at least one locking means (7). The securing rod (5) is thus, via at least one locking means (7), fixed or secured against a displacement in the through-hole (7). It is further represented that the securing rod (6) and the at least one side arm (3) are detachably connected with one another. Advantageously, the securing rod (6) is manufactured of a sheet-metal profile. The sheet-metal profile is advantageously formed in a n approximately I-, L-, U- or V-profile. It is likewise provided that the securing rod (6) is manufactured of a plastic material profile. The plastic material profile is likewise advantageously formed as an approximately I-, L-, U- or V-profile. As represented, the Y-shape stake (1) can be introduced into the ground with its bottom end of the base body (2).

In FIG. 2a, a cutaway through the base body (2) of a Y-shaped stake for fruit-growing is represented in plan view. As shown, the base body (2) comprises an approximately U-shaped cross-section (U-shaped profile). Hooks (8) are arranged on the limbs of the U. The limbs respectively comprise an insertion area on their ends (in profile), followed up by a hook. This configuration of the limbs is advantageous for the stability of the stake. As represented, the hooks (8) are arranged on the limbs proximate the back of the U-shaped profile. Through this configuration, the highest-possible stability against laterally-acting forces is achieved. The insertion area (in profile) additionally reinforces the statics.

In FIG. 2b, a cutaway of a base body (2) of a Y-shaped stake for fruit-growing with a substantially horizontal through-opening (5), as well as hooks (8) for the suspension of wires in viticulture and fruit-growing is represented in a perspective view.

In FIG. 2c, a hook (8) for the suspension of wires in viticulture and fruit-growing is shown in a side view. The hook (8) is formed as an upwardly open (to the upper end of the base body) single hook. It is provided that single hooks exclusively open to the upper end of the base body are arranged in the area of the wire frame for fruit-growing. The hooks (8) are formed by punching out a punch hole (not represented), and deformation of tongues out of the roughly U-profile. The hook (8) comprises a flank ascending out of the limb of the U-profile, wherein the flank merges into a tongue extending roughly parallel to the limbs, and the tongue comprises a hook member expanding towards the open end, which lies opposite a tapered section of the punch hole (not represented).

In FIG. 3, a releasable connection of the securing rod with the base body is represented in a perspective view. The locking means (7) comprise an inherently rigid stopper (7a) butting against the base body (2) in the locking position and provided for on the securing rod (6), as well as a spring-elastic sheet-metal tongue (7b) formed on the securing rod (3). The base body (2) consists of a U-shaped sheet-metal profile, namely two limbs (2b, 2c) and a connecting piece (2a) arranged at a right angle between the limbs. The U-shaped sheet-metal profile has been obtained via the punching-out and deformation of sheet metal. The securing rod (6) likewise consists of a sheet-metal profile, which was obtained through the punching-out and deformation of sheet metal. The securing rod (6) comprises a plurality of hooks and/or eyelets for holding of the wires. As further represented, the spring-elastic sheet-metal tongue (7b) is formed, through punching-out and deformation of a tongue-shaped section, out of the sheet-metal profile of the securing rod (6).

In FIG. 4, a Y-shaped stake (1) for fruit-growing is represented in a side view, wherein the base body is connectable with a net support cover (10) via at least one coupling means.

In the FIGS. 5a and 5b, the coupling means (11, 12) for a net support cover, which are arranged on the upper end of the base body (2), are represented. The coupling means can likewise serve the purpose of connecting multiple stakes in longitudinal or transversal direction. The latter configuration effects a stabilization of the stakes (among one another), whereby a lateral movement of the stakes to one another can be avoided. Wire cables, plastic cables, wires, or the similar can be used as coupling means.

1-11. (canceled)

12: A Y-shaped stake (1) for fruit-growing, wherein an elongated base body (2) and two side arms (3) are provided, wherein the base body (2) comprises openings (4) for the inserting of at least one side arm (3) each, wherein the inserted side arms (3) are angled toward the upper end of the base body (2), wherein, between the openings (4) and the upper end of the base body (2), a substantially horizontal through-opening (5) is provided, through which a securing rod (6) can be pushed through, wherein the securing rod (6) is horizontally securable against a displacement in the through-opening (5) via at least one locking means (7), and the securing rod (6) is detachably connectable with the at least one side arm (3), and wherein the at least one locking means (7) comprises an inherently rigid stopper (7a) abutting against the base body (2) in the locking position and provided for on the securing rod (6), as well as a spring-elastic sheet-metal tongue (7b) molded on the securing rod (3).

13: The Y-shaped stake (1) for fruit-growing according to claim 12, wherein the securing rod (6) comprises a sheet-metal profile.

14: The Y-shaped stake (1) for fruit-growing according to claim 13, wherein the spring-elastic sheet-metal tongue (7b) is formed through punching out and deformation of a tongue-shaped section out of the sheet-metal profile of the securing rod (6).

15: The Y-shaped stake (1) for fruit-growing according to claim 14, wherein the spring-elastic sheet-metal tongue (7b) includes a spring portion protruding out of the sheet-metal profile of the securing rod (6) at an angle of approx. 70° to 90°, preferably at approx. 80°, and a support portion running substantially parallel to the outer side of the securing rod, on the free end of which a support surface is formed, via which the securing rod, in the locking position, can be supported on the base body (2).

16: The Y-shaped stake (1) for fruit-growing according to claim 12, wherein the locking means (2) include a bore-hole in the securing rod (6), as well as a bore-hole in the base body (2), wherein the fastening means are pushable and securable through the bore-hole in the base body (2) and through the bore-hole in the securing rod (6).

17: The Y-shaped stake (1) for fruit-growing according to claim 12, wherein, in the area of the openings (4) and/or of the side arms (3), securing means for securing the side arms (3) inserted into the openings (4) are provided.

18: The Y-shaped stake (1) for fruit-growing according to claim 12, wherein, for the detachable connecting of the securing rod (6) with the side arms (3), a screw connection is respectively provided between the securing rod (6) and one of the side arms (3).

19: The Y-shaped stake (1) for fruit-growing according to claim 12, wherein the inserted side arms (3) are angled towards the upper end of the base body at an angle a of approx. 40° to 60°, preferably of approx. 50°.

20: The Y-shaped stake (1) for fruit-growing according to claim 12, wherein, on the upper end of the base body (2), at least one coupling means (11, 12) is arrangeable for a net support cover (10).

21: The Y-shaped stake (1) for fruit-growing according to claim 12, wherein the base body (2) comprises an approximately L-, U- or V-shaped profile, on which, in the area for the receiving of wire frames, outside-lying hooks (8) are arranged, wherein the hooks (8) in the area of the wire frames for fruit-growing, are formed as single hooks, wherein the hooks (8) are formed by punching out, to form a punched hole, and deforming of tongues out of the L-, U- or V-profile, and each of the hooks (8) comprises a flank protruding out of the limb of the approximately L-, U- or V-shaped profile, wherein the flank merges into a tongue running roughly parallel to the limbs, and the tongue comprises a hook member widening towards the open end, which lies opposite a tapered section of the punched hole.
